(19) United States
(12) Patent Application Publication
(10) Pub. No.: US 2007/0229683 A1
(43) Pub. Date: Oct. 4, 2007

(54) Color wheels, assemblies and methods of producing them

(75) Inventors: Lawrence E. Larson, Berkeley, CA (US); Jerry Gene Gage, Santa Rosa, CA (US); Peter C. Egerton, Windsor, CA (US); Vonn Sawatzky, Santa Rosa, CA (US); Christopher Weiland Hall, Lakeport, CA (US); Michael A. Scobey, Santa Rosa, CA (US)

Correspondence Address: BANNER & WITCOFF, LTD., 28 STATE STREET, 28th FLOOR, BOSTON, MA, 02109-9601, US

(73) Assignee: Bookham Technologies plc, Towcester (GB)

(21) Appl. No.: 11/397,335

(22) Filed: Apr. 4, 2006

(51) Int. Cl. H04N 9/04

(52) U.S. Cl. 348/269

(57) ABSTRACT

A color wheel comprises a plurality of light filters mounted on a hub or other mounting surface for rotation. The outer circumferential edge of the filters extend radially beyond the outer circumferential edge of the mounting surface. The mounting surface is beveled at its outer circumferential edge. The filters are mounted by adhesive between each filter and the mounting surface. The adhesive extends into at least a portion of the area between the bevel and the filters. Color wheel assemblies comprise such color wheels mounted to a rotational motor. The outer circumferential edges of the filters are aligned with each other to the same radial distance from the central rotational axis. In certain exemplary embodiments the filters are wedge shaped, having contact with adjacent filters only at their radially outer periphery. An automated method of making a color wheel assembly also is provided, wherein multiple filter segments are positioned on a mounting surface of a hub with UV curable adhesive which extends into at least a portion of the area between the bevel and the filters. An outer circumferential edge of each of the filter segments is aligned with each other to the same radial distance from the central rotational axis. Each of the filters is wedge shaped, having contact with adjacent filters only at their outer periphery. The UV curable adhesive is cured by exposure to UV radiation and the press-fitting the color wheel to a motor.

### BACKGROUND OF THE INVENTION

1. Field of the Invention

The present invention relates to color wheels suitable for use as light filters and to assemblies incorporating them and to methods of producing them.

2. Background

Certain projection display systems use a light modulator in combination with a white light source to produce a full color image. The white light source is filtered sequentially by different colored filters to produce a light beam whose color correspondingly changes over time. Typically, a color wheel is used to allow a series of primary colored filters arranged in a wheel to be spun through the white light beam in rapid succession. As each filter passes through the light beam, the light beam becomes a beam of that color. During each color period, data for the appropriate color is provided to a spatial light modulator to enable the modulator to create a series of single color images on a projection screen. If the single color images are created in sufficiently rapid sequence, the viewer's eye integrates the series of images to give the perception of viewing a single full-color image. For example, color wheels are used in various projection devices, typically being mounted on a motor for high-speed rotation through the light beam. So-called light engines may comprise one or more color wheels and a light source along with a micro-mirror device for directing the filtered light to a projection screen to create projected images.

The filters segments typically used in color wheels often are formed of optical glass plates with a suitable filter coating on one or both sides. In view of the very high-speed rotation and variable temperature and humidity conditions of operation, the filters segments must be robustly mounted. Nevertheless, the color wheel must be light weight and well balanced. Significant manufacturing challenges are encountered in view of the conflicting requirements of robustness, balance, low cost, consistency of product, etc.

It is an object of the present invention to provide improved color wheel assemblies. It is a particular object of at least certain embodiments of the disclosed invention to provide color wheel assemblies well adapted for use in projection display devices. It is another particular object of at least certain embodiments of the disclosed invention to provide color wheel assemblies well adapted to automatic or robotic assembly production methods. Additional objects and features of the color wheel assemblies of the present invention will be apparent from the following disclosure.

### SUMMARY

In accordance with a first aspect, a color wheel comprises a plurality of light filters, also referred to here as color wheel filter segments, mounted on a mounting surface for rotation. The filters are cantilevered or radially projecting in that each of the filters has an outer circumferential edge radially beyond the outer circumferential edge of the mounting surface. The mounting surface is beveled at its outer circumferential edge such that where the filters project beyond the hub there is a continuous or non-continuous, circumferential concavity between (i.e., at the edge of the interface between) the bevel and the filters. The filters are mounted by adhesive between each filter and the mounting surface, for example, epoxy, acrylic or other suitable adhesive. Certain exemplary embodiments employ thermally curable adhesive and/or UV curable adhesive. Certain exemplary embodiments employ adhesive which is both UV and thermally curable, as its rapid, consistent and predictable curing can provide significant advantages in manufacture of the color wheels, especially in automatic assembly of the color wheels (e.g., robotic assembly or the like). The adhesive extends into at least a portion of the circumferential concave area at the bevel, i.e., between the hub and the filters. In certain exemplary embodiments the filters are mounted solely by the adhesive bond to the mounting surface, thus having, for example, no supporting members or other mechanical framework between the filter segments, no through-holes receiving mounting pins or the like from or into the mounting surface, etc. The outer circumferential edges of the filters are aligned with each other to the same radial distance from the central rotational axis. As discussed further below, in certain exemplary embodiments of the color wheels disclosed here, each of the filters is wedge shaped, having contact with adjacent filters only at their outer periphery.

In certain exemplary embodiments, the mounting surface is the surface of a hub to which the color wheel filter segments are adhered. In other embodiment the color wheel filters are mounted directly to a motor, e.g., to a housing or other rotational component of an electric motor, air bearing motor or other suitable motor. The motor may have any suitable means for delivering rotational power to the color wheel, including, for example, a hollow or solid output shaft or other suitable power output member or feature. Where the filter segments are mounted to a hub, the hub may have any suitable configuration, e.g., it can be washer-shaped, that is, a flat ring or annulus. Optionally, the hub has an axially extending, radially central boss and forms a press-fit, that is, a friction fit with a shaft or other output member of a motor. Where the axial wall height of the central boss is greater than the axial thickness of the filters, the axial end surface of the boss can act as a stop, more specifically, a surface that contacts the motor when the color wheel is in position, such that the filters segments do not contact the motor. Such embodiments can provide advantages in the manufacture of the color wheels, especially in automatic production methods, as compressive stresses against the filter segments are reduced or avoided even during high-speed assembly of the color wheel to the motor. Moreover, variation in filter segment thickness is well tolerated by providing such clearance space. In addition, in certain exemplary embodiments the filters (i.e., the filter segments of the color wheel) do not contact the central boss. Rather, the outer circumferential edges of the filters are aligned with each other to the same radial distance from the central rotational axis without using the central boss as a stop or positioning feature. As further discussed below, in certain such exemplary embodiments each of the filters is wedge-shaped or even extra-wedge shaped and has only point contact with each of the adjacent filters. Such embodiments can provide advantages in the manufacture of the color wheels, especially in automatic production methods. Irregularities in the shape and/or dimensions of the filters segments is well tolerated in the assembly of such embodiments, as is edge roughness. Compressive stresses against the filter segments are reduced or avoided even during high-speed assembly of the color wheels.

In accordance with another aspect, an automated method of making a color wheel is provided. Multiple filter segments are positioned simultaneously on a mounting surface of a hub with UV curable adhesive. The filter segments may be placed in position on the mounting surface one or more at a time provided they are all simultaneously in position for the adhesive curing step. The hub has a beveled outer circumferential edge and a radially central boss with an axial wall height greater than the thickness of the filters. The adhesive extends into at least a portion of the area between the bevel and the filters. The outer circumferential edge of each of the filter segments is aligned with each other to the same radial distance from the central rotational axis. In certain exemplary embodiments the inner circumferential edge of each of the filter segments is radially spaced from the central boss. Each of the filters is wedge shaped, having contact with adjacent filters only at their outer periphery. The UV curable adhesive is exposed to UV radiation to cure the UV curable adhesive and form a color wheel. The color wheel then is fitted to the output member of a motor, e.g., to a generally cylindrical output member of a motor using a friction fit, force fit or locational fit, with the axial end surface of the boss acting as a positive stop against a surface of the motor. If a locational fit is used, the wheel is secured to the motor output member with adhesive.

In certain exemplary embodiments the color wheel is balanced to a high degree of precision such that vibration of the color wheel is low while rotating at high speed in normal operation, e.g., in accordance with international standard ISO 1940-1 balance grade G6.3 and in some embodiments to a limit of balance grade G2.5 or in certain embodiments even to a limit of balance grade G1. Balance correction can be achieved in one or two planes, depending upon the desired degree of precision, e.g., by acentric voids in the hub, that is, by drill holes or the like, removing material from off-center locations of the hub. Thus, for example, drill holes can be provided in both a face surface of the hub and an edge surface of the hub (e.g., the drill holes having longitudinal axes in planes perpendicular or at right angles to each other) for dual-plane balancing. Alternatively, material can be added in complementary locations to achieve the same result. Alternative balancing techniques for the color wheel assemblies disclosed here will be apparent to those skilled in the art given the benefit of this disclosure.

### BRIEF DESCRIPTION OF THE DRAWINGS

Certain exemplary embodiments are described below with reference to the attached drawings in which:

FIG. 1 is a perspective view of a hub suitable for a color wheel in accordance with one embodiment of the present disclosure, having a radially central boss;

FIG. 2 is a plan view of the hub of FIG. 1;

FIG. 3 is a section view of the hub of FIG. 1 taken through line 3-3 of FIG. 2;

FIG. 4 is a section view, partially broken away, of a color wheel in accordance with one embodiment of the present disclosure, with color wheel filter segments mounted to a hub of FIG. 1;

FIG. 5 is an exploded section view of a color wheel assembly in accordance with one embodiment of the present disclosure, employing a color wheel in accordance with FIG. 4;

FIG. 6 is a perspective view of the color wheel of FIG. 4;

FIG. 7 is a section view, partially broken away on color wheel assembly of FIG. 5, showing the hub of the color wheel seated on the motor;

FIG. 8 is a perspective view, partially broken away, of the color wheel employed in the color wheel assembly of FIGS. 5 and 7, showing the gap between the radially inner circumferential edge of the color wheel filter segment and the radially outer surface of the central boss of the hub; and

FIG. 9 is a schematic view, partially broken away, of the color wheel employed in the color wheel assembly of FIGS. 5 and 7, showing the contact between adjacent wedge-shaped color wheel filter segments at their outer periphery (i.e. at their radially outer circumferential area) and showing the gap between the side edges of the filter segments.

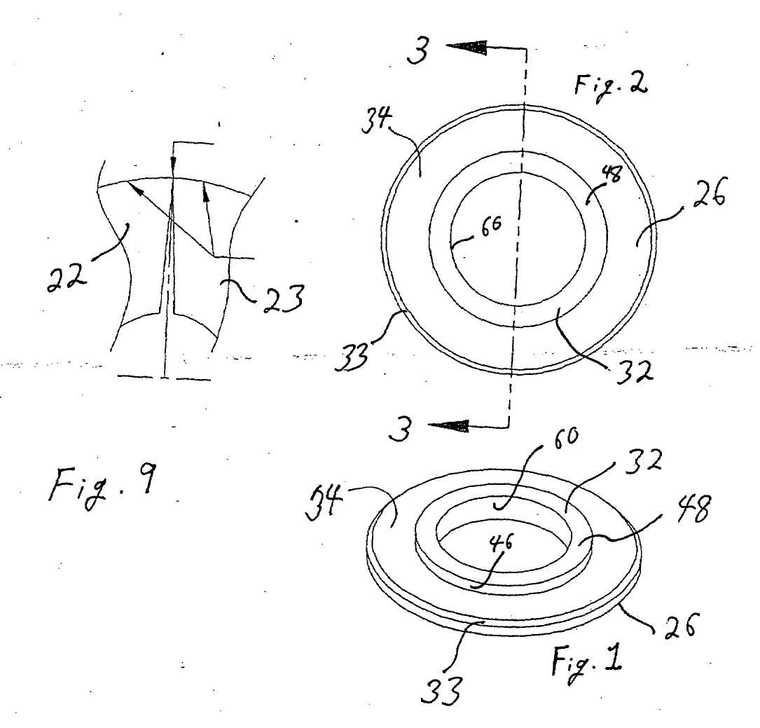

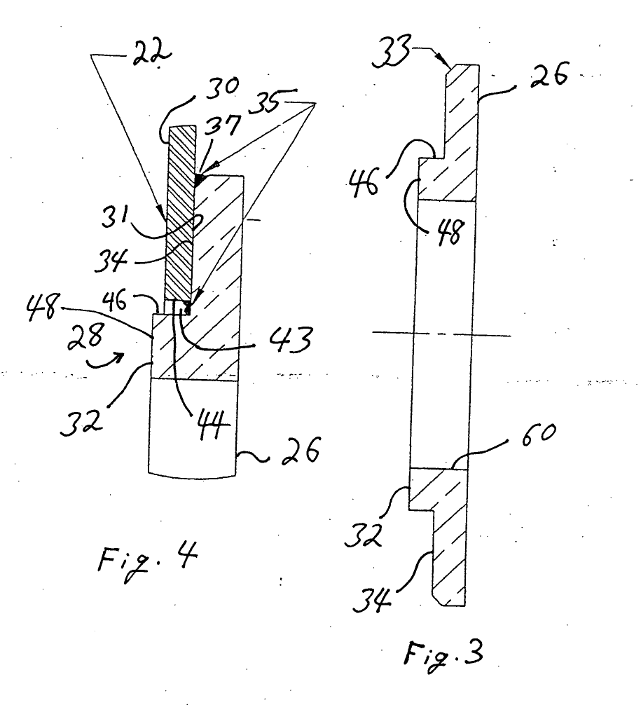

It will be recognized by those skilled in the art that the color wheel assemblies shown in the figures are not necessarily to scale. Additionally, references to orientation, e.g. top, bottom and the like, are for convenience purposes only and are not intended to limit the disclosure in any manner. One skilled in the art, given the benefit of this disclosure, will be able to select and design color wheel assemblies having dimensions, geometries and orientations suitable for the particular desired applications.

### DETAILED DESCRIPTION OF CERTAIN EXEMPLARY EMBODIMENTS

From the forgoing disclosure and the following discussion, it will be apparent to those skilled in the art, that is, to those who have knowledge or experience in this area of technology that many uses and design variations are possible for the color wheel assemblies disclosed here and for display devices and other products incorporating them. The following detailed discussion of various alternative and preferred embodiments and features will illustrate the general principles of the invention with reference to a color wheel assembly suitable for use in a light engine for a television or computer display. Other embodiments suitable for other applications, such will be apparent to those skilled in the art given the benefit of this disclosure.

The drawings illustrate a color wheel assembly 20 and its components, including a color wheel 28 having a set of four filter segments 22-25 mounted to a hub 26. The filter segments are formed of wedge-shaped optical glass substrates having a thin-film, wavelength selective coating on at least one surface, e.g., the surface facing the motor, such as surface 30 of filter segment 22. Suitable methods are well-known to those skilled in the art for producing the filter segments, including, for example, sputter deposition of the desired wavelength selective coating onto an optical glass disk and then cutting or sawing the disk into multiple wedge-shaped filter segments. The filters are selective for certain wavelengths or wavelength bands, that is, they are selectively transmissive, reflective and/or adsorptive of IR, UV, visible or other wavelengths or bands of wavelengths. In certain exemplary embodiments each of the filters is selective differently from either adjacent filter of the color wheel, although in certain embodiments two or more non-adjacent filters may be the same. For example, the filters may be thin film edge pass or band pass filters. Thus, as used here, “each of the filters is wavelength selective differently from adjacent filters” means that each of the filters is transmissive, reflective and/or adsorptive of wavelengths or of wavelength ranges different from those of the filters on either side of it in the color wheel. In certain exemplary embodiments the filters are formed by sputter deposition of Fabry-Perot filter coatings onto optical substrates which then are cut or diced into multiple filters. Alternative techniques will be apparent to those skilled in the art given the benefit of this disclosure.

Hub 26 is seen to be washer-shaped, that is, a flat ring with an axially extending, a radially centered mounting boss 32. Hub 26 provides a mounting surface 34 for adhesively mounting the filter segments of the color wheel. The outer circumferential edge 33 of the mounting surface is beveled. Adhesive 35, as best seen in FIG. 4, forms a film 31 of uniform thickness between the filter segments and the mounting surface 34 of the hub. In addition, excess adhesive extends into at least a portion of the area 37 between the bevel and the filters. That is, a fillet or generally rounded adhesive bead partially fills the internal angle between the surface of the filter and the surface of the bevel of the hub or other mounting surface to which the filters are mounted. Thus, the area 37 may be referred to as a reservoir for excess adhesive. In accordance with certain exemplary embodiments excess adhesive forms a substantially uniform, rounded bead or fillet in area 37. Stresses on the filter segments in certain exemplary embodiments are reduced by such beveled outer circumferential edge and the resulting adhesive reservoir area 37. Such stress reduction contributes to the robustness of the color filter wheels in accordance with at least certain exemplary embodiments of the present disclosure.

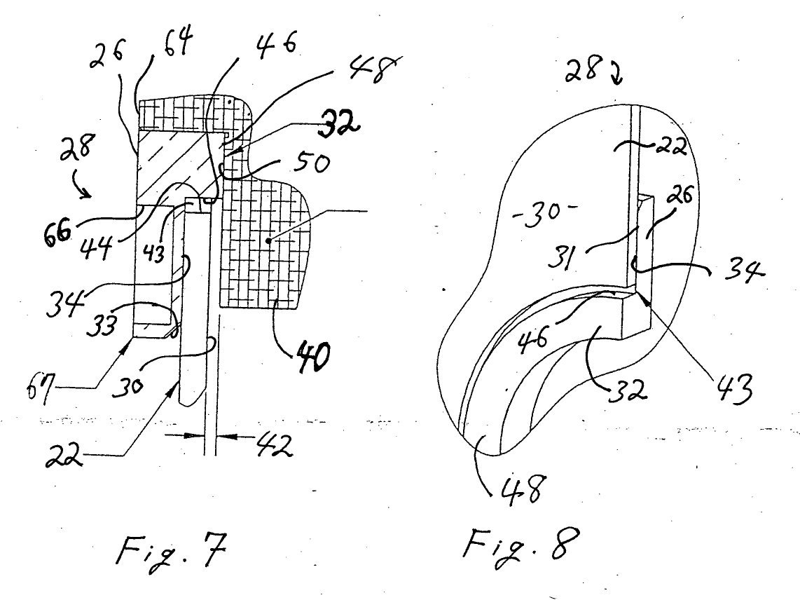

In the illustrated embodiment, the central through hole 60 in hub 26 is sized for a press-fit or friction fit 61 onto cylindrical output member 62 of motor 40. As best seen in FIGS. 4 and 7, central boss 32 has an axial height above the mounting surface 34 which is greater than the thickness of the filter segments. Upper surface 48 of mounting boss 32, as best seen in FIG. 7, seats against surface 50 of rotational motor 40. Thus, when assembled to motor 40, an axial gap 42 is created between the motor and the adjacent surface of the filter segments, such as surface 30 of filter segment 22. Also in the illustrated embodiment, the filters do not contact the central boss. That is, there is a radial gap 43 between the filter segments and the hub, more specifically, there is a gap 43 between the inner circumferential edge of the filters, such as surface 44 of the filter segment 22 (as best seen in FIGS. 4 and 7) and the radially outward circumferential surface 46 of the hub's central boss. Excess adhesive can flow into gap 43, thereby facilitating a uniform adhesive layer thickness between the filter segments and the mounting surface 34 of the hub 26. Such uniform adhesive layer thickness and the beveled outer circumferential edge 33 are believed to substantially contribute to the robustness of color wheels in accordance with at least certain exemplary embodiments of the present disclosure.

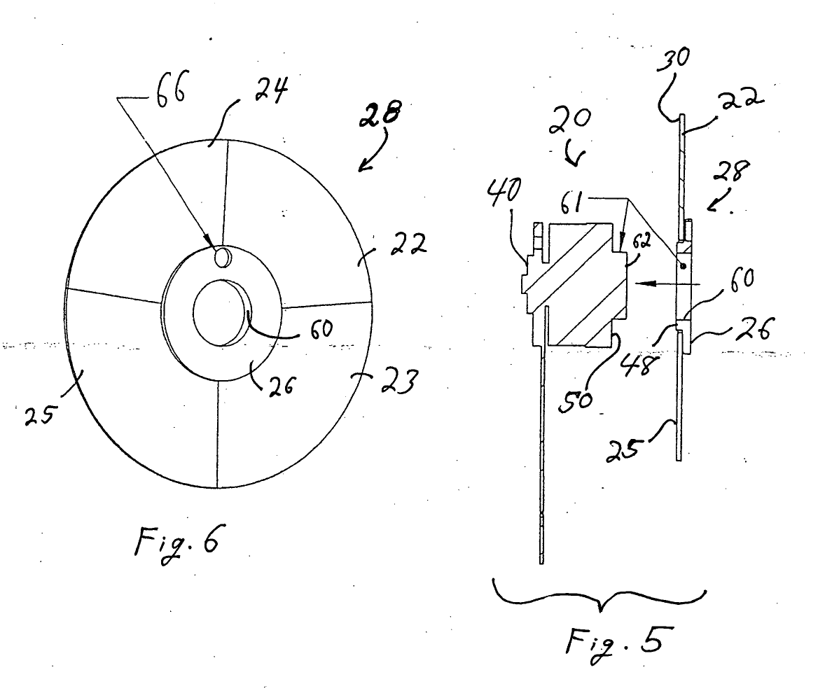

In accordance with certain exemplary embodiments, the hub is formed of dense material, for example, material having a density of at least 2.7 g/cm³ such as aluminum, or even material having a density of at least 8.5 g/cm³ such as brass. In accordance with certain exemplary embodiments, the color wheel is balanced prior to being mounted onto the motor. In the illustrated embodiment, as best seen in FIG. 6, color wheel 28 is balanced by removing material from hub 26. Specifically, material is removed by a drill hole 66 to an appropriate depth and/or diameter. Preferably the drill hole 66 leaves a wall 67 of sufficient thickness for structural robustness. Alternatively, multiple smaller holes can be employed. Alternatively, polls can be drilled radially rather than axially into the hub. Alternatively, material can be added to the hub, such as adhesive material or the like onto the surface or into a groove. Suitable alternative balancing techniques will be apparent to those skilled in the art given the benefit of the present disclosure.

In certain exemplary embodiments the filter segments are mounted either to a hub or directly to a motor (i.e., to a surface of a housing member of the motor or the like) with adhesive and additional mounting means, such as, e.g., having through-holes or other recesses in the filters to receive corresponding nubs or other protrusions upstanding from the mounting surface (perpendicular to the plane of rotation) and/or being clamped or sandwiched between opposing surfaces—the mounting surface and another surface. The term “sandwiched” here means having surface-to-surface pressure applied to both sides of the filter by such opposing surfaces. In certain exemplary embodiments the filters are mounted by adhesive alone. In such embodiments the filters have no through-holes to receive corresponding nubs and are not clamped or sandwiched between opposing surfaces.

As noted above, the outer circumferential edges of the filters are aligned with each other to the same radial distance from the central rotational axis. As used here, this means that (i) the average distance of each filter's outer circumferential edge from the central rotational axis is the same as that of the other filters of the color wheel, and/or (ii) the outermost point of each filter's outer circumferential edge (i.e., the point farthest from the central rotational axis) is at the same radial distance from the central rotational axis as that of the others. Typically, filters cut from larger substrates, e.g., from discs coated in a sputter deposition process or by other means, are not perfect in their geometry. That is, the cutting or dicing process is approximate and the filter's edges may be somewhat irregular. Therefore, in certain exemplary embodiments, in order to facilitate aligning the filters with each other at the same radial distance from the central rotational axis, the filters are generally wedge-like in shape, optionally being “extra-wedged.” The term “extra-wedged” is used here to mean that radially inward of the outer circumferential edges the filters are more narrow than would be necessary if the wedges could be perfectly formed to have uninterrupted edge-to-edge contact with the adjacent filters along their side edges. Thus, in certain such exemplary embodiments, each of the filters has only point contact with each of the adjacent filters. That is, in such embodiments the filters are not only aligned with each other to the same radial distance from the central rotational axis, but also contact each adjacent filter only at their outer periphery. As used here, the term “outer periphery” of a filter means its radially outer portion, that is, the portion of the filter at its outer circumferential edge. Such outer periphery may be taken for this disclosure to be the radially outermost twenty-five percent (25%) of the filter (measured as distance from the central rotational axis rather than as surface area). Thus, in certain exemplary embodiments wherein each of the filters of the color wheel has only point contact with the adjacent filters on either side, i.e., touches each adjacent filter at only one location, such point contact is at the outer periphery of the filters, i.e., within the radially outermost twenty-five percent (25%) of the filters. In certain preferred embodiments such point contact is within the radially outermost fifteen percent (15%) of the filters, and in certain high precision embodiments is within the radially outermost ten percent (10%) or less.

In accordance with another aspect, an automated method of making a color wheel assembly comprises positioning multiple filter segments simultaneously on a mounting surface of a hub with UV curable adhesive. The hub has a beveled outer circumferential edge, as disclosed above, and optionally a radially central boss with an axial wall height greater than the thickness of the filters. The adhesive can extend into the area between the bevel and the filters. An outer circumferential edge of each of the filter segments is aligned with each other to the same radial distance from the central rotational axis. In certain exemplary embodiments the inner circumferential edge of each of the filter segments is radially spaced from a central boss of the hub. Each of the filters is wedge shaped, optionally being extra-wedged, and has contact with adjacent filters only at their outer periphery. The adhesive can be an epoxy, acrylic or other suitable adhesive, preferably being UV curable adhesive such as Loctite 366 for the reasons discussed above. The adhesive is cured, for example, in the case of the UV curable adhesive by exposure to ultraviolet light. Alternatively, an adhesive that uses both ultraviolet light and heat as its curing mechanism, such as Loctite 3340 may be used. The resulting color wheel, after optionally being balanced, is then press-fitted onto a generally cylindrical output member of a motor. In those embodiments having a central boss, the axial end surface of the boss can act as a stop against the surface of the motor. Suitable alternative manufacturing techniques for the color wheels and color wheel assemblies disclosed here will be apparent to those skilled in the art given the benefit of this disclosure.

Although the present invention has been described above in terms of specific embodiments, it is anticipated that other uses, alterations and modifications thereof will become apparent to those skilled in the art given the benefit of this disclosure. Such alterations are intended to include the interchanging of one or more of the components of any of the embodiments with the components of any of the other embodiments disclosed here. It is intended that the following claims be read as covering such alterations and modifications as fall within the true spirit and scope of the invention. It is intended that the articles “a” and “an,” as used below in the claims, cover both the singular and plural forms of the nouns which the articles modify.

What is claimed is:

1. A color wheel comprising:
a mounting surface rotatable in a plane about a central rotational axis;
a plurality of light filters mounted for rotation with the mounting surface, each of the filters having an outer circumferential edge radially beyond an outer circumferential edge of the mounting surface; and
adhesive between each filter and the mounting surface;
wherein the outer circumferential edges of the filters are aligned with each other to the same radial distance from the central rotational axis.

2. The color wheel of claim 1 wherein each of the filters is wedge shaped, having contact with adjacent filters only at their outer periphery.

3. The color wheel of claim 1 wherein each of the filters contacts each adjacent filter only at the radially outermost 25% of the adjacent filters.

4. The color wheel of claim 1 wherein the mounting surface has a beveled outer circumferential edge and the adhesive extends into at least portions of a circumferential concave space between the bevel and the filters

5. The color wheel of claim 1 wherein the mounting surface is a surface of a hub such that the color filters are attached to the hub.

6. The color wheel of claim 5 wherein the hub has a radially central boss with an axial wall height greater than the axial thickness of the filters.

7. The color wheel of claim 6 wherein the filters do not contact the central boss.

8. The color wheel of claim 1 wherein the hub is mounted to an output shaft of a motor.

9. The color wheel of claim 1 wherein the adhesive comprises UV cured adhesive.

10. The color wheel of claim 1 wherein the color filters are attached directly to a motor housing.

11. A color wheel assembly comprising:
a motor; and
a color wheel comprising
a hub mounted to an output member of the motor and having a mounting surface rotatable in a plane about a central rotational axis, the mounting surface having a beveled outer circumferential edge;
a color wheel comprising a plurality of light filters mounted for rotation with the mounting surface, each of the filters having an outer circumferential edge radially beyond the outer circumferential edge of the mounting surface, with an area between the bevel and the filters; and
adhesive between each filter and the mounting surface, which adhesive extends into at least portions of the area between the bevel and the filters;
wherein the outer circumferential edges of the filters are aligned with each other to the same radial distance from the central rotational axis.

12. The color wheel of claim 11 wherein the motor is operative to rotate the motor at a rotational speed of at least 14,000 RPM and the color wheel is operative to withstand rotation at a rotational speed of at least 14,000 RPM for at least 100 hours at temperatures up to at least 85° C.

13. The color wheel assembly of claim 11 wherein the hub is mounted to the output member of the motor with a locational fit.

14. The color wheel assembly of claim 11 wherein the hub has a radially central boss with an axial wall height greater than the axial thickness of the filters, the axial end surface of the boss being a positive stop against a surface of the motor.

15. The color wheel of claim 11 wherein the hub is formed of a material having a density of at least 8.5 g/cm³.

16. The color wheel of claim 11 wherein the color wheel is balanced by an acentric void in the hub.

17. The color wheel of claim 11 wherein the color wheel is balanced to at least ISO 1940-1 balance grade G1.

18. The color wheel of claim 11 wherein the color wheel is dual-plane balanced.

19. The color wheel of claim 11 wherein the adhesive forms a uniform thickness layer between the mounting surface and the filters.

20. The color wheel of claim 19 wherein the adhesive also forms a uniform circumferential bead in the area between the bevel and the filters.

21. An automated method of making a color wheel assembly comprising:
positioning multiple filter segments simultaneously on a mounting surface of a hub with UV curable adhesive, the hub having a beveled outer circumferential edge and a radially central boss with an axial wall height greater than the thickness of the filters, wherein
adhesive extends into at least a portion of the area between the bevel and the filters,
an outer circumferential edge of each of the filter segments is aligned with each other to the same radial distance from the central rotational axis,
an inner circumferential edge of each of the filter segments is radially spaced from the central boss, and
each of the filters is wedge shaped, having contact with adjacent filters only at their outer periphery;
exposing the UV curable adhesive to UV radiation to cure the UV curable adhesive and form a color wheel;
press-fitting the color wheel to a generally cylindrical output member of a motor, the axial end surface of the boss acting as a positive stop against a surface of the motor.

22. The automated method of making a color wheel assembly in accordance with claim 21 wherein an inner circumferential edge of each of the filter segments is radially spaced from the central boss.

23. The automated method of making a color wheel assembly in accordance with claim 21 wherein the UV curable adhesive is curable by both ultraviolet light and heat as its curing mechanisms and the step of applying UV radiation to cure the adhesive comprises also applying heat to cure the adhesive.
